(19) United States
(12) Patent Application Publication
(10) Pub. No.: US 2011/0295685 A1
(43) Pub. Date: Dec. 1, 2011

(54) METHOD AND SYSTEM FOR TRANSMITTING AND ADVERTISING COMPANY INFORMATION

(75) Inventor: Yung Seong Lee, Seongnam-si (KR)

(73) Assignee: NHN BUSINESS PLATFORM CORPORATION, Seongnam-si (KR)

(21) Appl. No.: 13/131,772

(22) PCT Filed: Dec. 2, 2009
(86) PCT No.: PCT/KR09/07151

§ 371 Date: Aug. 16, 2011

(30) Foreign Application Priority Data
Dec. 2, 2008 (KR) 10-2008-0121081
Dec. 2, 2008 (KR) 10-2008-0121082

(51) Int. Cl. G06Q 30/00

(52) U.S. Cl. 705/14.49; 705/14.69

(57) ABSTRACT

An advertisement method that transfers company information and a system to perform the method are provided. The company information transferring advertisement system includes a page display unit to display company information and a company information transfer icon on a content page, an information transfer unit to transfer the company information to a destination when the company information transfer icon is selected, and a charge unit to charge the company with a transfer fee for the company information.

### CROSS-REFERENCE TO RELATED APPLICATIONS

This application is the National Stage Entry of International Application PCT/KR2009/007151, filed on Dec. 2, 2009, and claims priority from and the benefit of Korean Patent Application No. 10-2008-0121081, filed on Dec. 2, 2008, and Korean Patent Application No. 10-2008-0121082, filed on Dec. 2, 2008 which are incorporated herein by reference for all purposes as if fully set forth herein.

### FIELD OF THE INVENTION

The present invention relates to an advertisement method and system that capable of transferring company information.

### DISCUSSION OF THE BACKGROUND

Content pages include a local information page that searches for and displays a company located in a specific locale.

The local information page shows information on the searched company along with a sketch map of the vicinity of the searched company, thus providing convenience to a user who wants to travel to the company directly. As such, the local information page is being widely used.

However, since the sketch map is displayed on the local information page, a user has to print out or record the sketch map separately on an offline medium to make use of the sketch map while travelling to the company.

In addition, since the local information page does not show review comments about the company or evaluations of the company, the user has to perform searching separately and visit blogs of other users to check the review comments about the company or evaluations of the company.

At the same time, the company would like to acquire as many review comments about the company, as possible, on a homepage or a relevant details page of the company, and to show the review comments about the company to many users for advertising. However, most users are likely to leave review comments about the company on their blogs rather than on the homepage or the relevant details page of the company. As a consequence, the company has a great deal of difficulty in securing lots of review comments about the company.

Accordingly, there is a demand for a new method and system capable of transferring information related to a company, such as the sketch map, to a destination such as a mobile terminal so that the information can be used when a user visits the company, and also capable of automatically collecting and uploading review comments about the company on the homepage or the relevant details page of the company.

The content pages include the local information page that searches for and displays a company located in a specific locale.

The local information page shows information on the searched company along with a sketch map to the searched company, thus providing convenience to a user who wants to directly visit the company. Therefore, the local information page can be widely used.

However, since the local information page displays companies at random around a specific locale or companies having similar names, even though the company-related information is exposed to users, a company cannot achieve effective advertising if the users do not desire to access detailed information of the company.

The company may offer a discount coupon or a gift certificate for users who visit the details page of the company. However, at great inconvenience, the users have to print out or record and carry identifier information of the coupon or gift certificate separately.

Furthermore, some users may suspect that a price of a product is set in consideration of the coupon or gift certificate. Consequently, sales usually increase when the coupon is offered by other pages rather than a detailed page of an advertiser.

Consequently, there is a demand for a method or system enabling an advertiser to advertise his or her company through the company of the advertiser and another company having a high possibility of being exposed on the local information page, and also enabling a user to use a coupon offered by the advertiser at offline stores conveniently.

### SUMMARY OF THE INVENTION

An aspect of the present invention provides a company information transferring advertisement system further displaying an icon for transfer of company information, such as a sketch map or contact information, to a user terminal when displaying the company on a content page, thereby enabling a user to check the company information through the user terminal even while moving.

Another aspect of the present invention provides a company information transferring advertisement system enabling a user conveniently to receive company information, by charging a company with a fee for transferring the company information to a destination, and also enabling the company to be informed of a number of users, with interest in the company, receiving the company information.

Another aspect of the present invention provides a company information transferring advertisement system that induces review comments or appreciation comments of users, by charging the company information transfer fee to the company when the users send their review comments or appreciation comments regarding the company in reply to the company information, and attracts interest of other users by uploading the replied comments on a details page of the company.

Another aspect of the present invention provides a company information transferring advertisement system that enables a user to conveniently write review comments regarding a company when editing a blog, by providing the user with an editor function using a company information database (DB), and attracts interest of other users by automatically uploading, on a details page of the company, the comments uploaded on the blog.

Another aspect of the present invention provides a company information transferring advertisement system that displays a cooperative product of a cooperative company, such as a coupon, on a detailed page of an advertiser while displaying a cooperative product of the advertiser on a detailed page of the cooperative company, thereby inducing a user who visits the cooperative company to view the cooperative product of the advertiser or another cooperative company and visit the advertiser or the other cooperative company.

Another aspect of the present invention provides a company information transferring advertisement system that transfers cooperative information to a portable destination, thereby enabling a user to use the cooperative information conveniently at offline stores without printing or recording the information separately.

Another aspect of the present invention provides a company information transferring advertisement system that enables a user to receive cooperative information with ease, by charging a cooperative company with a fee for transferring the cooperative information to a destination, and also enables the cooperative company to be informed of a quantity of users receiving the cooperative information with interest in a product of the cooperative company.

According to an aspect of the present invention, there is provided a company information transferring advertisement system including a page display unit to display company information and a company information transfer icon on a content page, an information transfer unit to transfer the company information to a destination when the company information transfer icon is selected, and a charge unit to charge the company with a transfer fee for the company information.

The company information may include at least one of a sketch map to the company, an address of the company, and contact information of the company.

The charge unit may further charge the company with an advertising fee caused by transfer of the company information.

The advertisement system may further include a receive unit to receive reply information with respect to the company information from the destination, and an upload unit to upload the reply information on a detailed page corresponding to the company information, wherein the charge unit may charge the company with a transfer fee for the reply information.

The advertisement system may further include a blog unit to store the blog corresponding to the destination and to provide the blog with an editor function using a company information database (DB).

The blog unit may transfer information related to a specific company linked with the blog to the upload unit when the information related to the specific company is uploaded, and the upload unit may upload the information related to the specific company on a details page corresponding to the specific company.

According to an aspect of the present invention, there is provided an advertisement method for transferring company information, including displaying company information and a company information transfer icon on a content page, transferring the company information to a destination when the company information transfer icon is selected, and charging the company with a transfer fee for the company information.

According to an aspect of the present invention, there is provided a cooperative company intermediary advertisement system including an intermediary unit to select a cooperative company with reference to a target of an advertiser, a cooperative database (DB) to store information on the cooperative company and a cooperative product set between the advertiser and the cooperative company, and a product sending unit to display a send icon for sending of the cooperative product on a detailed page of the advertiser and to send the cooperative product stored in the cooperative DB to a destination when the send icon is selected.

The advertisement system may further include a charge unit to charge the cooperative company with a fee for sending the cooperative product.

The charge unit may further charge the cooperative company with an advertising fee caused by sending of the cooperative product.

The product sending unit may display a plurality of the send icons corresponding to a number of the cooperative companies and a type of the cooperative products provided by the cooperative companies.

According to an aspect of the present invention, there is provided a cooperative company intermediary advertisement method including selecting a cooperative company with reference to a target of an advertiser, storing information on the cooperative company and a cooperative product set between the advertiser and the cooperative company, displaying a send icon for sending of the cooperative product on a details page of the advertiser, and sending the cooperative product to a destination when the send icon is selected.

According to an embodiment of the present invention, an icon for transfer of company information, such as a sketch map or contact information, to a user terminal is further displayed when the company is displayed on a content page. Therefore, a user is able to check the company information through the user terminal even while moving.

According to an embodiment of the present invention, a user may conveniently receive company information since a company is charged with a fee for transferring the company information to a destination. Also, the company may be informed of a number of users receiving the company information with interest in the company.

According to an embodiment of the present invention, review comments or appreciation comments of users may be induced since the company is charged with the company information transfer fee when the users send their review or appreciation comments regarding the company in reply to the company information. In addition, interests of other users may be attracted when the replied comments are uploaded on a details page of the company.

According to an embodiment of the present invention, an editor function using a company information database (DB) is provided to a user so that the user may conveniently write review comments regarding a company when editing a blog. In addition, the comments uploaded on the blog may be automatically uploaded on a details page of the company, thereby attracting interest of other users

According to an embodiment of the present invention, a cooperative product of a cooperative company, such as a coupon, is displayed on a details page of an advertiser whereas a cooperative product of the advertiser is displayed on a details page of the cooperative company. Therefore, a user who visits the cooperative company is induced to see the cooperative product of the advertiser or another cooperative company and visit the advertiser or another cooperative company.

According to an embodiment of the present invention, a company information transferring advertisement system transfers cooperative information to a portable destination, thereby enabling a user to conveniently use the cooperative information at offline stores without separate printing or recording.

According to an embodiment of the present invention, a company information transferring advertisement system enables a user to receive cooperative information with ease, by charging a cooperative company with a fee for transferring the cooperative information to a destination, and also enables the cooperative company to be informed of a quantity of users receiving the cooperative information with interest in a product of the cooperative company.

### BRIEF DESCRIPTION OF THE DRAWINGS

FIG. 1 illustrates a structural view of a company information transferring advertisement system according to an embodiment of the present invention;

FIG. 2 illustrates a diagram for describing an example of a content page using a company information transferring advertisement system according to an embodiment of the present invention;

FIG. 3 illustrates a flowchart for describing a company information transferring advertisement method according to an embodiment of the present invention;

FIG. 4 illustrates a diagram for describing an example information flow between respective parts in a company information transferring advertisement method according to an embodiment of the present invention;

FIG. 5 illustrates a structural view of a cooperative company intermediary advertisement system according to an embodiment of the present invention;

FIG. 6 illustrates a diagram for describing an example content page using a cooperative company intermediary advertisement system according to an embodiment of the present invention;

FIG. 7 illustrates a flowchart for describing a cooperative company intermediary advertisement method according to an embodiment of the present invention; and

FIG. 8 illustrates a diagram for describing an example of using a cooperative company intermediary advertisement system according to an embodiment of the present invention.

### DETAILED DESCRIPTION OF THE ILLUSTRATED EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

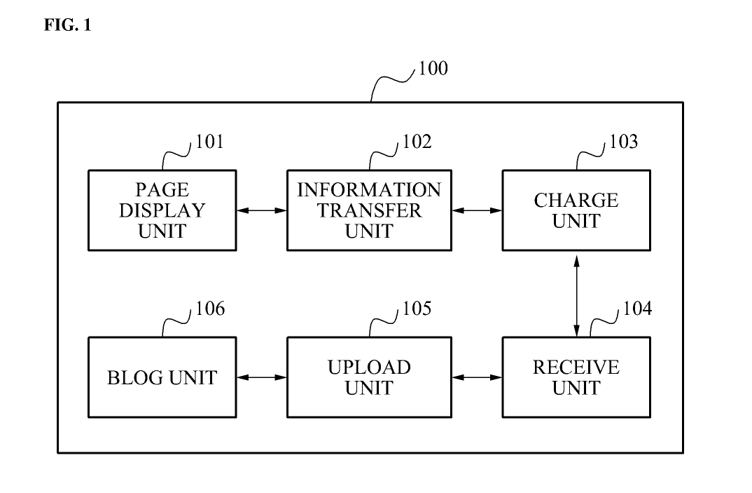

FIG. 1 illustrates a structural view of a company information transferring advertisement system 100 according to an embodiment of the present invention.

Referring to FIG. 1, the company information transferring advertisement system 100 is configured such that a page display unit 101 displays information on a company and a company information transfer icon on a content page, an information transfer unit 102 transfers the company information to a destination when the company information transfer icon is selected, and a charge unit 103 charges the company with a transfer fee for the company information. The information on the company may include at least one of a sketch map showing a location of the company, information on a company corresponding to the sketch map, and detailed information of each company.

When a receive unit 104 receives reply information with respect to the company information from the destination, an upload unit 105 uploads the reply information on a detailed page corresponding to the company information. Accordingly, the charge unit 103 may charge the company with a fee for transferring the reply information. Here, the details page corresponding to the company information may be a detailed page included in a homepage of the company.

A blog unit 106 may be further included, which stores a blog corresponding to the destination and provides the blog with an editor function using a company information database (DB).

The content page may be a page that searches for and displays a company located in a specific locale.

The company information may include at least one of a sketch map to the company, an address of the company, and contact information of the company. An exemplary embodiment includes at least the sketch map to the company.

The information transfer unit 102 may display a destination input window and transfer the company information to a destination input through the destination input window or to a pre-stored destination. Here, the destination may be identifier information of a mobile terminal of a user who selects the company information transfer icon.

When the user requests transfer of the company information, it is considered that the user is interested in the company and an advertising effect occurs. Therefore, the charge unit 103 may further charge the company with an advertising fee for the transfer of the company information.

The reply information received by the receive unit 104 may include at least one of an image related to a place corresponding to the sketch map or the address, review comments about the place, and appreciation comments about the place.

The upload unit 105 may upload the reply information on a details page corresponding to the company information and a blog corresponding to the destination, simultaneously.

The blog unit 106 may be set to link a specific company with each blog. Here, when information related to the specific company linked with the blog is uploaded, the blog unit may transfer the information related to the specific company to the upload unit 105. Accordingly, the upload unit may upload the information related to the specific company on a details page corresponding to the specific company.

The information related to the specific company may be review comments or appreciation comments regarding the specific company.

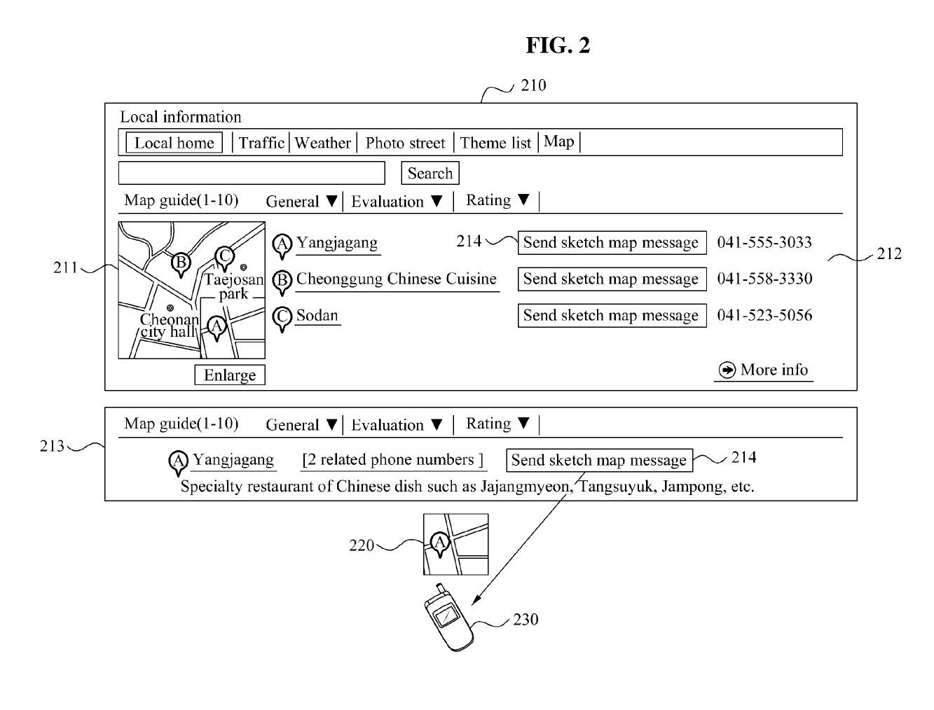

FIG. 2 illustrates a diagram showing an example of a content page using a company information transferring advertisement system 100 according to an embodiment of the present invention.

Referring to FIG. 2, the company information transferring advertisement system 100 may further display a company information transfer icon such as a map message transfer icon 214 for each company on a content page 210 through which companies located in a specific locale are searched for and displayed along with a sketch map 211 showing a location of at least one company, information 212 on a company corresponding to the sketch map 211, and detailed information 213 of each company.

When the map message transfer icon 214 is selected by a user, the company information transferring advertisement system 100 may transfer a map 220 showing the company corresponding to the selected map message transfer icon 214 to a mobile terminal 230 of the user.

The map 220 may be a sketch map 211 showing a location of at least one company, or a sketch map marking only the company corresponding to the map message transfer icon 214 while omitting other marks. Also, the map 220 may be a sketch map showing only an enlarged surrounding area of the company corresponding to the map message transfer icon 214.

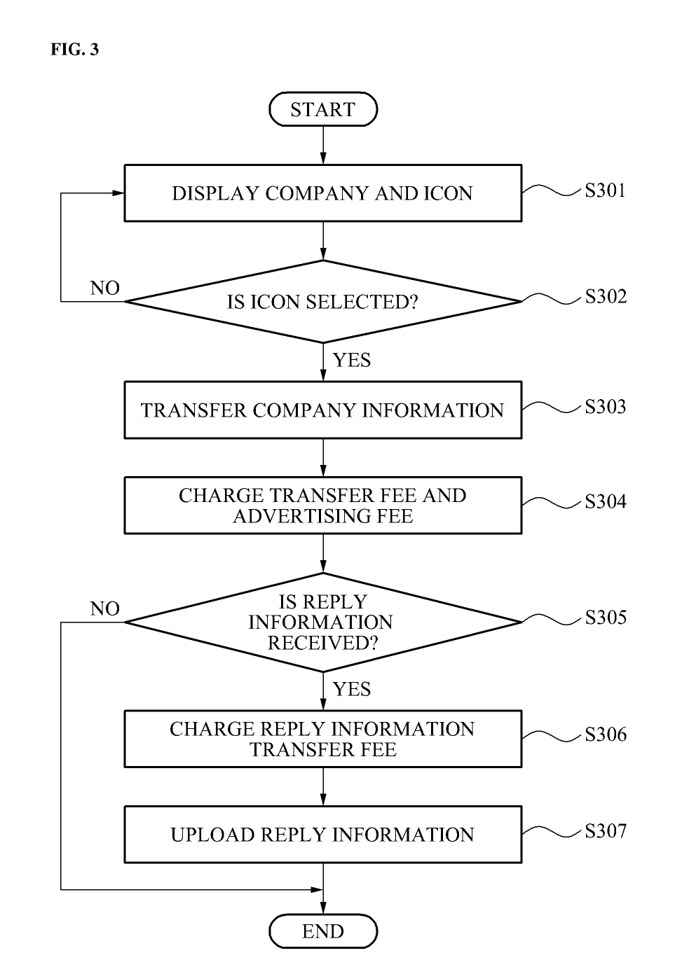

FIG. 3 illustrates a flowchart of a company information transferring advertisement method according to an embodiment of the present invention.

In operation S301, the page display unit 101 may show information on a company and a company information transfer icon, on a content page that searches for and displays a company located in a specific locale.

In operation S302, the information transfer unit 102 may check whether the company information transfer icon is selected. Here, more specifically, the information transfer unit 102 may check whether a destination of a user who selected the company information transfer icon is preset and, if not, display a destination input window to be input by the user with the destination for receiving the company information.

In operation S303, the information transfer unit 102 may transfer the company information to the destination.

Here, the company information may include at least one of a sketch map, an address of the company, and contact information of the company. It is exemplary that the company information includes at least the sketch map to the company.

In operation S304, the charge unit 103 may charge the company with a fee for transferring the company information transferred in operation S303.

In operation S305, the receive unit 104 may check whether reply information with respect to the company information is transferred in operation S304.

Here, the reply information may include at least one of an image related to a place corresponding to the sketch map or the address, review comments related to the place, and appreciation comments related to the place.

In operation S306, the charge unit 103 may charge the company with a fee for transferring the reply information transferred in operation S303.

In operation S307, the upload unit 105 may upload the reply information transferred in operation S303 on a detailed page corresponding to the company information. Here, the upload unit 105 may upload the reply information on the detailed page corresponding to the company information and on a blog corresponding to the destination, simultaneously.

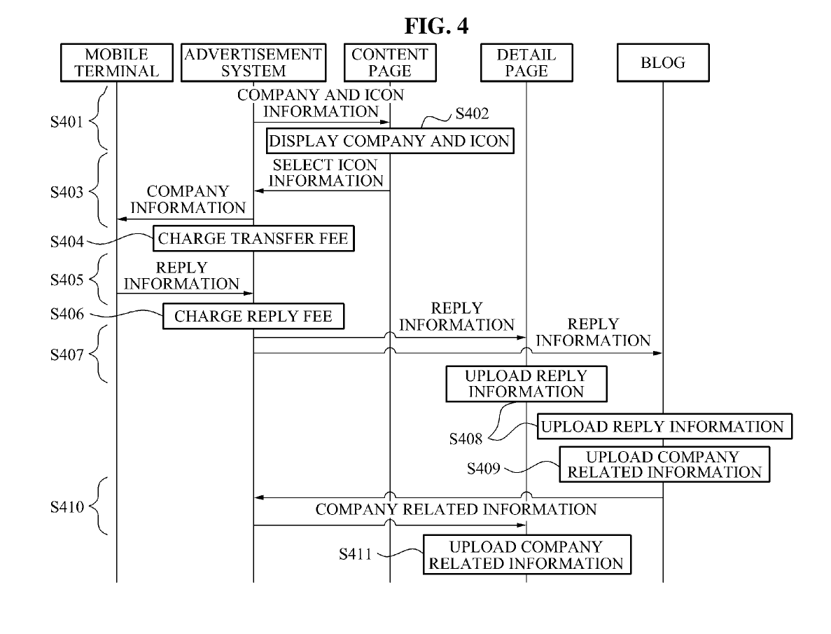

FIG. 4 illustrates an example of an information flow between respective parts in a company information transferring advertisement method according to an embodiment of the present invention.

In operation S401, the company information transferring advertisement system 100 may transfer information on a company and a company information transfer icon to a content page.

In operation S402, the content page may display the information on the company and the company information transfer icon. Specifically, the content page checks whether the company information transfer icon is selected. When the company information transfer icon is selected, the content page acquires information on a destination to which the company information is to be transferred.

In operation S403, the company information transferring advertisement system 100 may transfer the company information to the destination acquired in operation S403. Specifically, the content page may transfer, to the company information transferring advertisement system 100, information on the company corresponding to the selected company information transfer icon and information on the destination to which the company information is to be transferred. Accordingly, the company information transferring advertisement system 100 may transfer the company information to the destination corresponding to the received information. When the destination is a mobile terminal, the company information transferring advertisement system 100 may transfer the company information, including a sketch map and contact information of the company, to the destination using a short message service (SMS) or a multimedia message service (MMS).

In operation S404, the company information transferring advertisement system 100 may charge the company corresponding to the selected company information transfer icon, with a transfer fee for the company information transferred to the destination. Here, the company information transferring advertisement system 100 may further charge the company with an advertising fee caused by transfer of the company information.

In operation S405, the company information transferring advertisement system 100 may receive reply information with respect to the company information transferred in operation S404. Here, the reply information may include at least one of an image related to a place corresponding to the sketch map or the address, review comments related to the place, and appreciation comments related to the place.

In operation S406, the company information transferring advertisement system 100 may charge the transfer fee for the reply information replied to the receive unit, to the company of which the company information transfer icon is selected.

In operation S407, the company information transferring advertisement system 100 may transfer the reply information received in operation S405 to a detailed page corresponding to the company information and to a blog corresponding to the destination, simultaneously.

In operation S408, the detailed page and the blog may upload the reply information received in operation S405.

In operation S409, the blog may check whether information related to a specific company linked to the blog is uploaded.

In operation S410, the blog may transfer the information related to the specific company, to the company information transferring advertisement system 100. Accordingly, the company information transferring advertisement system 100 may transfer the information related to the specific company to the detailed page.

In operation S411, the detailed page may upload the information related to the specific company being received.

When the company is displayed on the content page, the company information transferring advertisement system may transfer the company information such as the sketch map and the address to a destination desired by the user. Therefore, the user may use the company information without printing out the company information separately.

The transfer fee for transfer of the company information to the destination may be charged to the company, so that the user may conveniently receive the company information. Conversely, the company may acquire information on how many users, with interest in the company, received the company information. In addition, when the user requests for transfer of the company information, it may be considered that the user is interested in the company and an advertising effect occurs. Therefore, the company information transferring advertisement system may further charge the company with an advertising fee.

Also, review comments or appreciation comments of users may be induced by charging the company with the fee for transferring the company information when the users send their review comments or appreciation comments regarding the company in reply to the company information. Moreover, interests of other users may be attracted when the replied comments are uploaded on a details page of the company.

Additionally, an editor function using a company information database (DB) may be provided to the user so that the user may write comments conveniently regarding the company when editing the blog. Furthermore, the comments being uploaded on the blog may be automatically uploaded on the detailed page of the company, thereby attracting interest from other users.

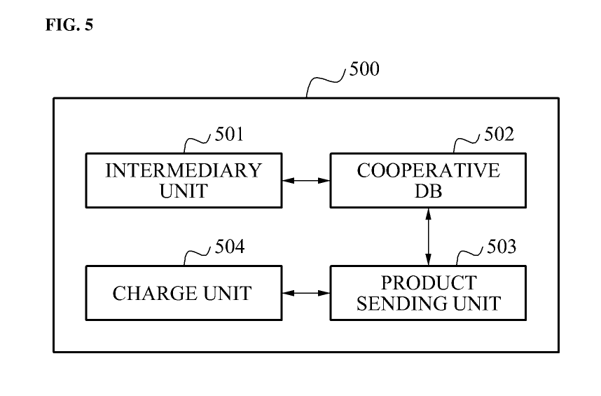

FIG. 5 illustrates a structural view of a cooperative company intermediary advertisement system 500 according to an embodiment of the present invention.

Referring to FIG. 5, the cooperative company intermediary advertisement system 500 may be configured as follows. When a cooperative company is selected by an intermediary unit 501 with reference to a target of an advertiser, a cooperative DB 502 stores information on the cooperative company and a cooperative product set between the advertiser and the cooperative company. A product sending unit 503 may display a cooperative product send icon on a detailed page of the advertiser. When the cooperative product send icon is selected, the cooperative product stored in the cooperative (DB) 502 may be sent to a destination. A charge unit 504 may charge the cooperative company with a fee for sending the cooperative product.

The cooperative product may include at least one of a discount coupon and a gift certificate corresponding to the cooperative company. The cooperative product may be used only when a product is purchased from the cooperative company.

The destination may be identifier information of a mobile terminal of the user who selected the cooperative product send icon.

When the intermediary unit 501 selects companies proper for cooperation with reference to the target of the advertiser and supplies the companies to the advertiser, the advertiser may select and make a cooperative contract with a company to cooperate with the companies, and store the cooperative company contracted for cooperative with the advertiser. The cooperative contract may include a contract about a type and quantity of the cooperative product mutually traded between the advertiser and the cooperative company.

The target may include at least one of a location where an advertisement is exposed, a location where a company of the advertiser is located, a business type of the advertiser, and a target of the advertisement. The intermediary unit 501 may search for companies having similar targets as the companies proper for cooperation.

The advertiser may be an advertiser who registered an advertisement on a content page that searches for and displays a company located in a specific locale. Here, the target may be another company that may be displayed when searching for the company of the advertiser.

The detailed page of the advertiser, the detailed page for displaying the cooperative product send icon, may be displayed when the advertisement of the advertiser displayed on the content page is selected.

The cooperative product send icon displayed by the product sending unit 503 may be an icon for sending the cooperative product stored in the cooperative DB.

The product sending unit 503 may display a plurality of the cooperative product send icons corresponding to a number of the cooperative companies and a type of the cooperative products provided by the cooperative companies.

Here, the product sending unit 503 may not display an advertiser cooperative product send icon provided by the advertiser, on the details page of the advertiser.

In addition, the product sending unit 503 may display the advertiser cooperative product send icon provided by the advertiser, on a detailed page of the cooperative company. When the advertiser cooperative product send icon is selected, the product sending unit 503 may send an advertiser cooperative product to a destination. The charge unit 504 may charge the advertiser with a sending fee for the advertiser cooperative product.

Additionally, the charge unit 504 may further charge the cooperative company with an advertising fee caused by sending of the cooperative product.

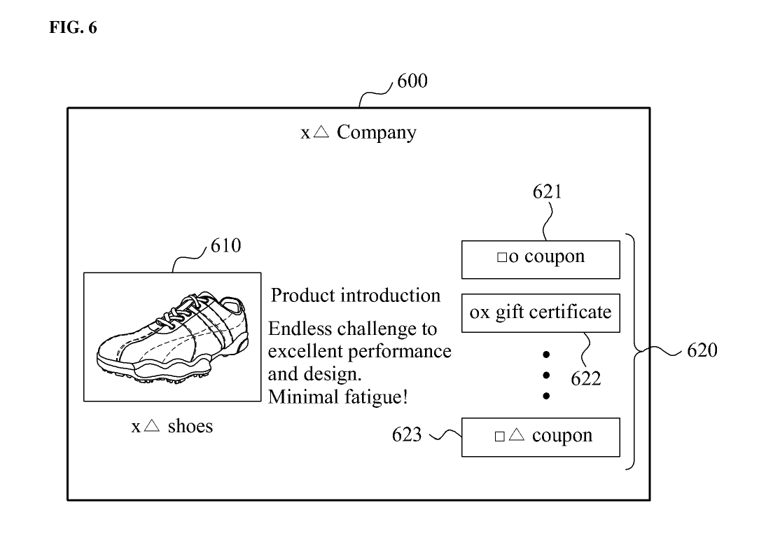

FIG. 6 illustrates a diagram describing an example content page using a cooperative company intermediary advertisement system 500 according to an embodiment of the present invention.

Referring to FIG. 6, the cooperative company intermediary advertisement system 500 may further display a cooperative product send icon 620 for sending a user a cooperative product of a cooperative company that made a cooperative contract with the advertiser, on a partial region of a details page 600 of the advertiser, the detailed page for displaying an advertised product 610 of the advertiser.

As shown in FIG. 6, the cooperative product send icon 620 may include a plurality of cooperative product send icons 621, 622, and 623 displayed on one detailed page 600, corresponding to the number of the cooperative companies and the type of the cooperative products provided by the cooperative companies.

Furthermore, since the plurality of cooperative product send icons 621, 622, and 623 do not include the cooperative product of the advertiser, a misconception that the advertiser should provide a coupon for increasing sales may be prevented.

Additionally, the cooperative product may include the coupon send icons 621 and 623 for sending a coupon offering a discount of the advertised product of the cooperative company, and a gift certificate send icon 622 for sending a gift certificate available only when the advertised product of the cooperative company is purchased.

Here, when the cooperative company send icon 620 is selected by the user, the cooperative company intermediary advertisement system 500 may send the cooperative product corresponding to the cooperative product send icon 620 to a mobile terminal of the user.

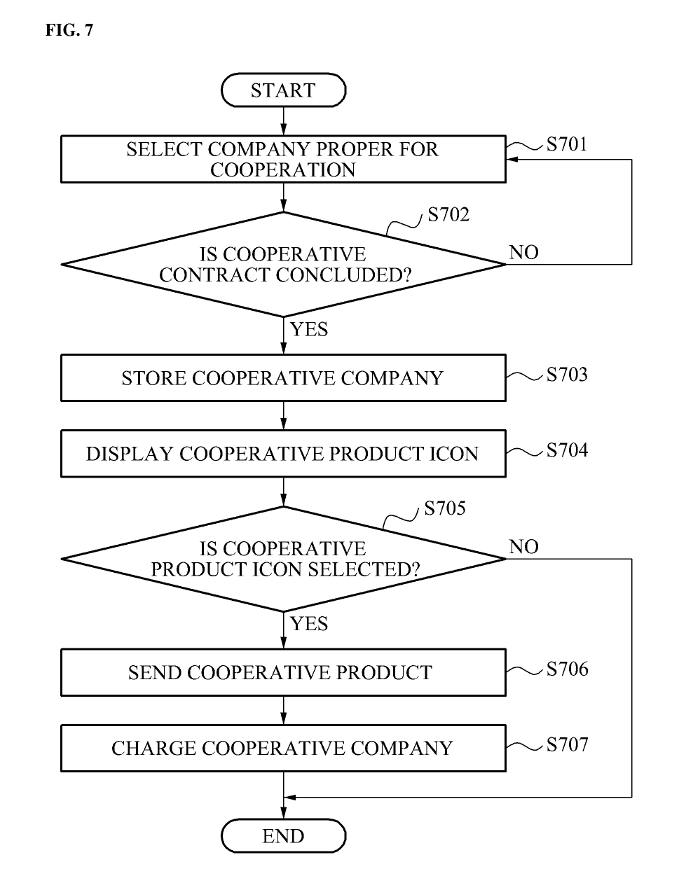

FIG. 7 illustrates a flowchart for describing a cooperative company intermediary advertisement method according to an embodiment of the present invention.

In operation S701, the intermediary unit 501 may select a cooperative company with reference to a target of an advertiser. More specifically, the intermediary unit 501 may select companies proper for cooperation with reference to the target of the advertiser and supplies the selected company to the advertiser. Therefore, the advertiser may select and make a cooperative contract with a company to cooperate with the companies.

In operation S702, the intermediary unit 501 checks whether the cooperative contract is made. More specifically, the intermediary unit 501 may confirm the company contracted for cooperation among the cooperative companies selected in operation S701.

In operation S703, the cooperative DB 502 may store information on the cooperative company confirmed to be contracted for cooperation in operation S702. Here, the cooperative DB 502 may further store the cooperative product contracted for cooperation between the advertiser and the cooperative company.

In operation S704, the product sending unit 503 may display the cooperative product send icon on a details page of the advertiser.

In operation S705, the product sending unit 503 may check whether the cooperative product send icon displayed in operation S704 is selected.

In operation S706, the product sending unit 503 may search for, from the cooperative DB 502, a cooperative product corresponding to the cooperative product send icon selected in operation S705 and send the searched cooperative product to a destination designated by a user. Here, the destination may be a mobile terminal of the user.

In addition, the cooperative product may include at least one of a discount coupon and a gift certificate corresponding to the cooperative company, and may be available only when a product is purchased from the cooperative company.

In operation S707, the charge unit 504 may charge the cooperative company that provided the cooperative product with a fee for sending the cooperative product sent in operation S706.

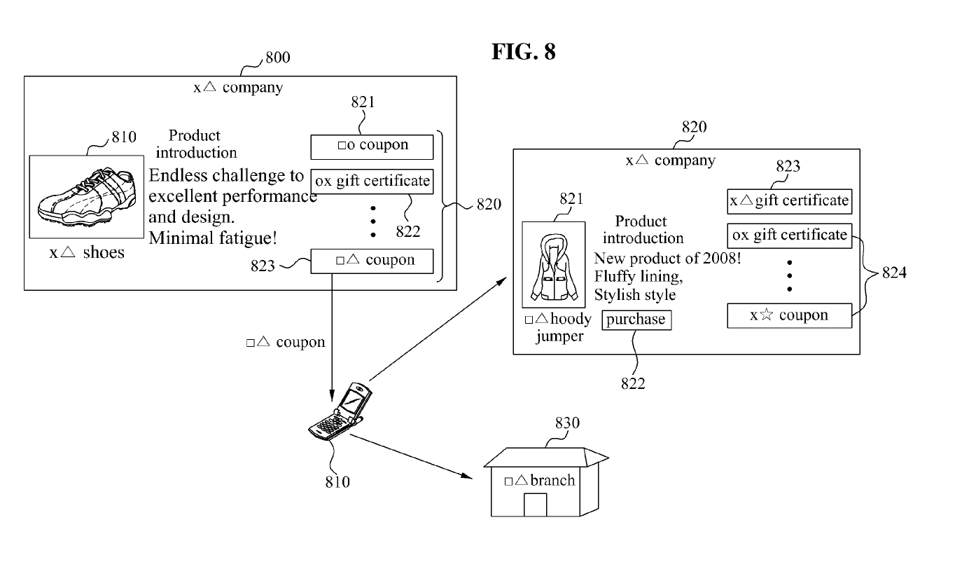

FIG. 8 illustrates a diagram describing an example of using a cooperative company intermediary advertisement system according to an embodiment of the present invention.

Referring to FIG. 8, a details page 600 of an advertiser displays an advertised product 610 of an advertiser and cooperative product send icons 620 for sending a user a cooperative product of a cooperative company that made a contract for cooperative with the advertiser. When one 623 of the cooperative product send icons 620 is selected by the user, the cooperative company intermediary advertisement system 500 may send a cooperative product coupon corresponding to the selected cooperative product send icon 623 to a mobile terminal 810 of the user.

Here, the cooperative product coupon may be available when an advertised product using a product purchase icon 822 is purchased through a details page 820 of the cooperative company, the details page 820 displaying an advertised product 821 of the cooperative company, the product purchase icon 822, and cooperative product send icons 823 and 824.

The details page 820 may display the cooperative product send icon 823 corresponding to the advertiser, instead of the cooperative product send icon 623 corresponding to the cooperative company.

Also, the cooperative product coupon may be used at an offline store 830 that sells the advertised product of the cooperative company. In this case, the user may use the cooperative product coupon without the need for printing out or offline-recording the cooperative product coupon, by carrying the mobile terminal 810 to the offline store 830 and displaying the cooperative product coupon on the mobile terminal 810 at the offline store 830.

The cooperative company intermediary advertisement system displays a cooperative product such as a coupon of a cooperative company, on a details page of an advertiser, while displaying a cooperative company of the advertiser on a detailed page of the cooperative company. Since the cooperative companies advertise each other, a user who visited one of the cooperative companies and checked a cooperative product of an advertiser or another cooperative company may be effectively induced to visit the advertiser or another cooperative company.

Further, since the cooperative information is transferred to a portable destination, the user may conveniently present the cooperative information without printing or recording the cooperative information separately when using the cooperative information at an offline store.

Also, since the transfer fee for transfer of the cooperative information to the destination is charged to the cooperative company, the user may receive the cooperative information with ease. The cooperative company may be informed of a quantity of users, with interest in a product of the cooperative company, who received the cooperative information.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An advertisement apparatus comprising:
a page display unit to display company information and an icon for requesting to transfer the company information on a content page;
an information transfer unit to transfer the company information to a destination in response to detection the company information transfer icon being selected; and
a charge unit to charge a fee for transferring the company information.

2. The advertisement apparatus of claim 1, wherein the company information comprises at least one of a sketch map, an address, or contact information of the company.

3. The advertisement apparatus of claim 1, wherein the content page comprises information for searching and displaying a company located in a specific locale.

4. The advertisement apparatus of claim 1, wherein the destination comprises identifier information of a mobile terminal associated with the selection of the icon for requesting to transfer the company information.

5. The advertisement apparatus of claim 1, wherein the charge unit further configured to charge the company with an advertising fee for transferring the company information.

6. The advertisement apparatus of claim 2, further comprising:
a receive unit to receive reply information with respect to the company information from the destination; and
an upload unit to upload the reply information on a detailed page corresponding to the company information,
wherein the charge unit is configured to charge the company with a fee for transferring the reply information.

7. The advertisement apparatus of claim 6, wherein the reply information comprises at least one of an image related to a place corresponding to the sketch map or the address, review comments about the place, or appreciation comments about the place.

8. The advertisement apparatus of claim 6, wherein the upload unit is configured to simultaneously upload the reply information on the detailed page corresponding to the company information and on a blog corresponding to the destination.

9. The advertisement apparatus of claim 8, further comprising:
a blog unit to store the blog corresponding to the destination and to provide the blog with an editor function using a company information database (DB).

10. The advertisement apparatus of claim 9, wherein
the blog unit is configured to transfer information related to a specific company linked with the blog to the upload unit in response to detection the information related to the specific company being uploaded, and
the upload unit is configured to upload the information related to the specific company on a detailed page corresponding to the specific company.

11. A method for transferring company information, the method comprising:
displaying company information and an icon for requesting to transfer the company information on a content page;
transferring the company information to a destination in response to detection the company information transfer icon being selected; and
charging the company with a fee for transferring the company information.

12. The method of claim 11, wherein the company information comprises at least one of a sketch map, an address, or contact information of the company.

13. The method of claim 11, further comprising:
providing information for searching a company located in a specific locale and displaying the company on the content page.

14. The method of claim 11, wherein the destination comprises identifier information of a mobile terminal associated with the selection of the icon for requesting to transfer the company information.

15. The method of claim 11, wherein the charging further comprises charging the company with an advertising fee for transferring the company information.

16. The method of claim 12, further comprising:
receiving reply information with respect to the company information from the destination;
uploading the reply information on a detailed page corresponding to the company information; and
charging the company with a fee for transferring the reply information.

17. The method of claim 16, wherein the reply information comprises at least one of an image related to a place corresponding to the sketch map or the address, review comments about the place, or appreciation comments about the place.

18. The method of claim 16, wherein the uploading comprises simultaneously uploading the reply information on the details page corresponding to the company information and on a blog corresponding to the destination.

19. The method of claim 18, further comprising:
uploading information related to a specific company, the specific company linked with a blog corresponding to the destination, on a detailed page corresponding to the specific company in response to detection the information related to the specific company being uploaded.

20. An advertisement system comprising:
an intermediary unit to determine a cooperative company based on an advertisement target of an advertiser;
a cooperative database (DB) to store information of the cooperative company and a cooperative product determined between the advertiser and the cooperative company; and
a product sending unit to display an icon for requesting to send the cooperative product on a detailed page of the advertiser and to send the cooperative product in response to detection the icon being selected.

21. The advertisement system of claim 20, wherein the advertisement target comprises at least one of a location where an advertisement is exposed, a location where a company of the advertiser is located, a business type of the advertiser, or a target of an advertisement.

22. The advertisement system of claim 20, wherein the cooperative product comprises at least one of a discount coupon or a gift certificate corresponding to the cooperative product.

23. The advertisement system of claim 20, wherein the cooperative product is usable associated with the selection of the icon of the cooperative company.

24. The advertisement system of claim 20, wherein the destination comprises identifier information of a mobile terminal associated with the selection of the icon for requesting to transfer the information.

25. The advertisement system of claim 20, wherein the advertiser is an advertiser who registered an advertisement on a content page comprising information for searching and displaying a company located in a specific locale.

26. The advertisement system of claim 20, wherein the detailed page of the advertiser comprises a page displayed in response to detection of an advertisement of the advertiser being selected from the content page.

27. The advertisement system of claim 20, further comprising:
a charge unit to charge the cooperative company with a fee for sending the cooperative product.

28. The advertisement system of claim 27, wherein the charge unit is further configured to charge the cooperative company with an advertising for sending the cooperative product.

29. The advertisement system of claim 20, wherein the product sending unit is configured to display a plurality of the icons corresponding to a number of the cooperative companies and a type of the cooperative products provided by the cooperative companies.

30. The advertisement system of claim 29, wherein the product sending unit is configured not to display an icon corresponding to an advertiser cooperative product provided by the advertiser on the detailed page of the advertiser.

31. The advertisement system of claim 29, wherein
the product sending unit is configured to display a send icon corresponding to an advertiser cooperative product provided by the advertiser on a detailed page of the cooperative company, and to send the advertiser cooperative product in response to detection of the send icon corresponding to the advertiser cooperative product being selected, and
the charge unit is configured to charge the advertiser with a fee for sending the advertiser cooperative product.

32. A method comprising:
selecting a cooperative company according to an advertisement target of an advertiser;
storing information of the cooperative company and a cooperative product determined between the advertiser and the cooperative company;
displaying an icon for requesting to send the cooperative product on a detailed page of the advertiser; and
sending the cooperative product to a destination in response to detection the send icon being selected.

33. The method of claim 32, wherein the target comprises at least one of a location where an advertisement is exposed, a location where a company of the advertiser is located, a business type of the advertiser, or a target of an advertisement.

34. The method of claim 32, wherein the cooperative product comprises at least one of a discount coupon or a gift certificate corresponding to the cooperative product.

35. The method of claim 32, wherein the cooperative product is usable associated with the selection of the icon of the cooperative company.

36. The method of claim 32, wherein the destination comprises identifier information of a mobile terminal associated with the selection of the icon for requesting to transfer the information.

37. The method of claim 32, wherein the advertiser is an advertiser who registered an advertisement on a content page comprising information for searching and displaying a company located in a specific locale.

38. The method of claim 32, wherein the detailed page of the advertiser comprises a page displayed in response to detection of an advertisement of the advertiser being selected from the content page.

39. The method of claim 32, further comprising:
charging the cooperative company with a fee for sending the cooperative product.

40. The method of claim 39, wherein the charging further comprises charging the cooperative company with an advertising fee for sending the cooperative product.

41. The method of claim 32, wherein the displaying of the icon comprises displaying a plurality of the icons corresponding to a number of the cooperative companies and a type of the cooperative products provided by the cooperative companies.

42. The method of claim 41, wherein the product sending unit is configured not to display an icon corresponding to an advertiser cooperative product provided by the advertiser on the detailed page of the advertiser.

43. A non-transitory computer readable storage medium comprising an executable program, which when executed, performs the method of claim 11.

44. A non-transitory computer readable storage medium comprising an executable program, which when executed, performs the method of claim 32.
